(19) United States
(12) Patent Application Publication
(10) Pub. No.: US 2002/0054972 A1
(43) Pub. Date: May 9, 2002

(54) Hardbanding material and process

(76) Inventors: Lloyd Charpentier, Spring, TX (US); Al Siegmund, Houston, TX (US)

Correspondence Address: Alan R. Thiele, JENKENS & GILCHRIST, P.C., Suite 3200, 1445 Ross Avenue, Dallas, TX, 75202-2799, US

(21) Appl. No.: 09/974,083

(22) Filed: Oct. 10, 2001

Related U.S. Application Data
(60) Provisional application No. 60/238,935, filed on Oct. 10, 2000.

(51) Int. Cl. B32B 1/08; B65D 1/00; F16K 31/383; E21B 7/00; F16K 31/143

(52) U.S. Cl. 428/36.91; 175/57; 251/62; 166/54.5

(57) ABSTRACT

The present invention describes a hardbanding material and a process for producing a hardbanding material which greatly extends the life of tool joints and sections of steel pipe to which the material is applied. Granules of tungsten carbide are dropped into a melt puddle which is formed when a low carbon chrome based alloy is welded to an outside surface of a drill pipe. The tungsten carbide has a size ranging from about 25/40 to about 40/60 mesh, with a hardness greater than 3000 HV. Alternatively, the tungsten carbide has a size of 40/60 mesh with a hardness of greater than 1700 HV.

### REFERENCE TO RELATED APPLICATION

This application claims the benefit of U.S. Provisional Application for Patent No. 60/238935 titled “Improved Hardbanding Process for Tool Joints” filed on Oct. 10, 2000 for priority under 35 U.S.C. § 119(e), is related thereto, is commonly assigned therewith, and incorporates herein by reference in its entirety the subject matter thereof.

### BACKGROUND OF THE INVENTION

1. Technical Field

The present invention pertains to hardbanding of tool joints or sections of steel pipe, and more particularly, to hardbanding of tool joints or sections of steel pipe used for drilling wells in the oil and gas industry.

2. Description of the Prior Art

In the metallurgy arts, hard-facing is the process by which a layer of hard, abrasion-resistant metal is applied to a less resistant metal part by plating, welding, spraying, or other techniques. Hardbanding is the process used to increase the hardness of a pipe or joint by adding a master alloy to a melt during the welding process. The benefits of this process are decreased casing wear and extended tool or pipe longevity. The process is utilized in various industries, particularly those in which demanding drilling requirements result in extreme casing wear, such as the oil and gas industry. Presently, hardbanding is performed using either an alloy material which is welded around the tool joint or a combination of a mild steel which is embedded with tungsten carbide during the welding process. Typically, the hardness of such types of hardbanding material is 1800 HV. While this hardness is effective, it has been realized that if a still harder coating is placed on a tool joint, then casing wear can be further reduced and tool joint life further extended.

### BRIEF SUMMARY OF THE INVENTION

The present invention describes a hardbanding material and a process for producing a hardbanding material which provides a significantly harder coating than that currently utilized in the drilling industry. This metallurgy process produces a material which greatly reduces casing wear when compared to traditional tungsten carbide hardfacings. The hardbanding material of the present invention is based on a low carbon chromium-based alloy which creates a smooth surface and extends the life of tool joints. Moreover, the method utilized to apply this hardbanding material is a cost effective process.

### BRIEF DESCRIPTION OF THE DRAWING FIGURES

A better understanding of the present invention may be had by reference to the drawing figures, wherein:

FIG. 1 is an illustration of the hardbanding locations for drill collars and heavyweight drillpipe;

FIG. 2 is an illustration of the hardbanding material with a raised application;

FIG. 3 is an illustration of the hardbanding material with a fully recessed application; and

FIG. 4 is an illustration of the application of the hardbanding material as an overlay, primarily for used drill pipe.

### DETAILED DESCRIPTION OF THE INVENTION

The present invention provides a hardbanding material and a process of producing a hardbanding material which greatly extends the life of tool joints and sections of steel pipe to which the material is applied. The hardbanding material is formulated from a low carbon chromium-based alloy. The use of this alloy results in a crack-free application which can be applied in a cost effective process.

While the low carbon chromium-based alloy is being welded to the tool joint, granules of tungsten carbide are dropped into the melt puddle. In one embodiment of the present invention, the tungsten carbide granules are about 25/40 mesh to about 40/60 mesh with a hardness of greater than 3000 HV. Another embodiment of the present invention utilizes tungsten carbide granules of about 40/60 mesh with a hardness greater than 1700 HV, which will also provide satisfactory results. These granules of tungsten carbide are much smaller than those which are normally used, resulting in a smoother, harder hardbanding surface.

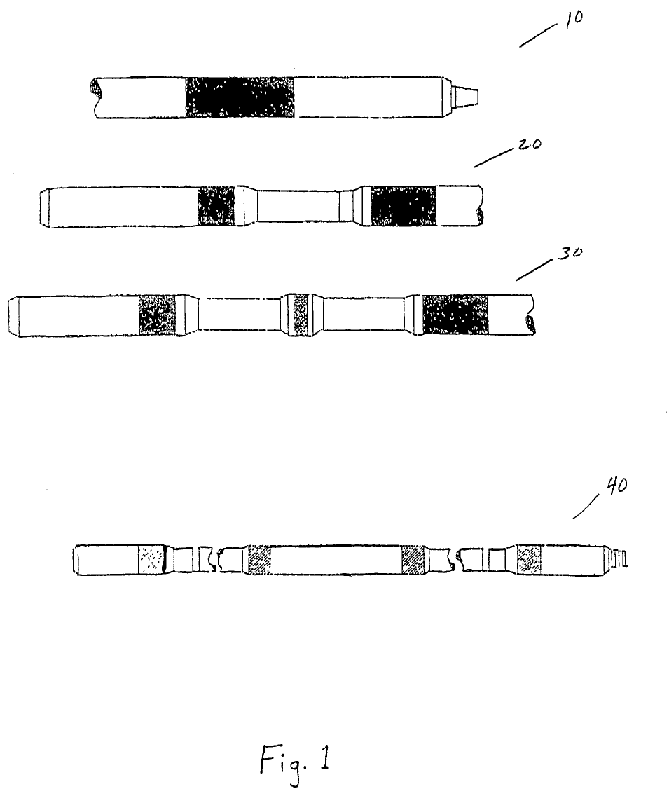

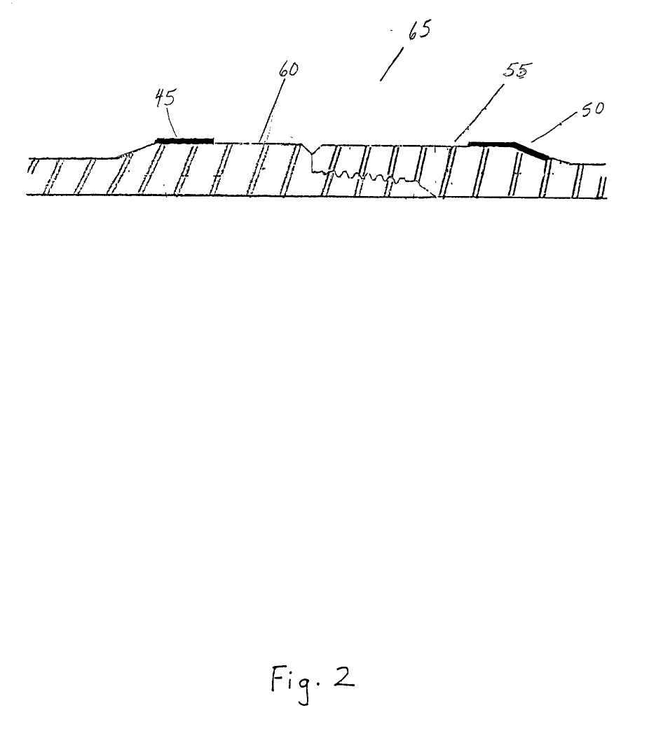

FIG. 1 illustrates the hardbanding locations for a drill collar with slip recess 10, a drill collar with slip and elevator recess 20, and a slick collar 30. Also illustrated in FIG. 1 is the location of hardbanding for heavyweight drillpipe 40. FIG. 2 demonstrates the application of the hardbanding to produce a raised bearing surface 45 and 50 on the box end 55 and pin end 60, respectively, of the tool joint 65 which reduces tool joint contact with the formation and casing. This bearing effect reduces friction and minimizes outside diameter tool joint wear and casing wear.

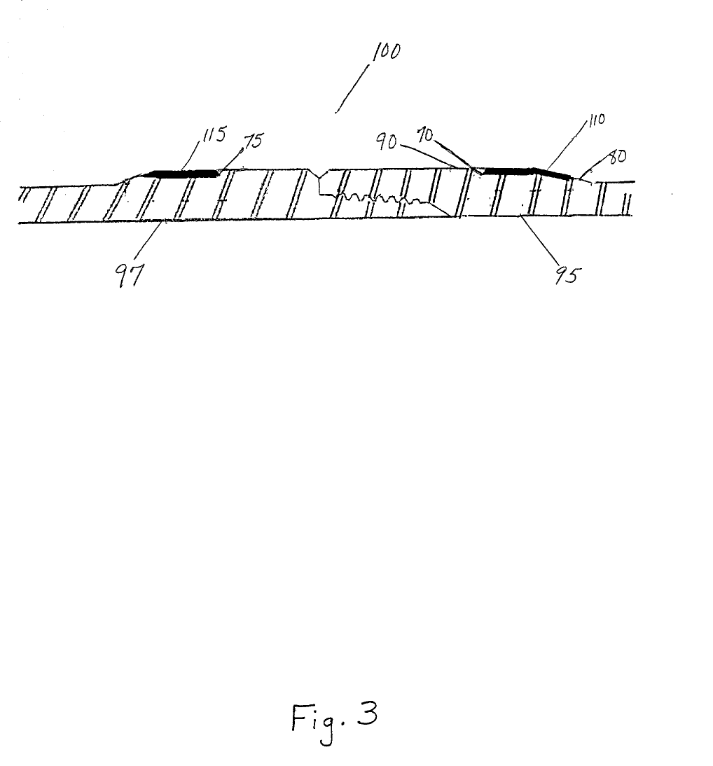

FIG. 3 illustrates a fully recessed application of the hardbanding material which is utilized to accommodate specific tool joint dimensional requirements. A recess 70 is machined into the elevator 80 and outside diameter 90 of the box end 95 of the tool joint 100. The hardbanding material 110 is applied flush to the same outside diameter 90 as the tool joint 100. FIG. 3 also illustrates the application of hardbanding material 115 in a recess 75 at the pin end 97 of the tool joint 100.

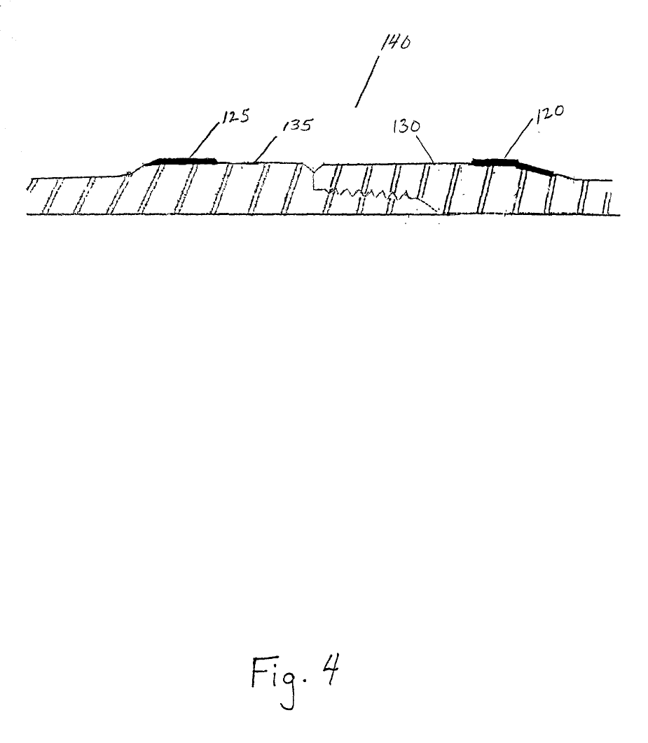

The hardbanding is easily applied in the field and does not require special shielding gases during the application. The material can be applied to internally coated drill pipe and can also be reapplied to an existing application of the material, primarily for used drill pipe. FIG. 4 illustrates this overlay application of the hardbanding material 120 and 125 on both the box end 130 and the pin end 135 of the used drill pipe 140.

The use of the material of the present invention is appropriate for more demanding drilling requirements where casing wear is a major concern. One of the embodiments of the present invention includes a raised application to both pin and box that creates a smooth bearing surface between casing and tool joint.

The material and process of the present invention has been disclosed by reference to its preferred embodiment. Those of ordinary shill in the art will understand that additional embodiments of the disclosed material and process are made possible by the foregoing disclosure. Such additional embodiments shall fall within the scope and meaning of the appended claims.

1. A material for hardbanding an end of a section of steel pipe, said material comprising:
a low carbon chrome based alloy; and
tungsten carbide granules.

2. The material as defined in claim 1, wherein the section of steel pipe is used in a drill string and an oil and gas well.

3. The material as defined in claim 1, wherein the tungsten carbide granules have a size ranging from about 25/40 to about 40/60 mesh, with a hardness greater than 3000 HV.

4. The material as defined in claim 1, wherein the tungsten carbide granules have a size of 40/60 mesh with a hardness of greater than 1700 HV.

5. A process for producing a hardbanded drill pipe whereby granules of tungsten carbide are dropped into a melt puddle which is formed when a low carbon chrome based alloy is welded to an outside surface of the drill pipe.

6. The process as defined in claim 5, wherein the drill pipe is used in a drill string and an oil and gas well.

7. The process as defined in claim 5, wherein the hardbanded material is welded to the outside diameter of the drill pipe to form a raised surface on the drill pipe.

8. The process as defined in claim 5, wherein a recess is machined into the outside diameter of the drill pipe and the hardbanding material is welded to the recess in the outside surface of the drill pipe to form a flush surface with the outside diameter of the drill pipe.

9. The process as defined in claim 5, wherein said tungsten carbide granules have a size ranging from about 25/40 to about 40/60 mesh, with a hardness greater than 3000 HV.

10. The process as defined in claim 5, wherein said tungsten carbide granules have a size of 40/60 mesh with a hardness of greater than 1700 HV.

11. A drill pipe formed according to the process defined in claim 5.

12. A drill pipe formed according to the process defined in claim 5, wherein the hardbanded material is welded to the outside diameter of the drill pipe to form a raised surface on the drill pipe.

13. A drill pipe formed according to the process as defined in claim 5, wherein a recess is machined into the outside diameter of the drill pipe and the hardbanding material is welded to the recess in the outside surface of the drill pipe to form a flush surface with the outside diameter of the drill pipe.

14. A drill pipe formed according to the process as defined in claim 5, wherein said tungsten carbide granules have a size ranging from about 25/40 to about 40/60 mesh, with a hardness greater than 3000 HV.

15. A drill pipe formed according to the process as defined in claim 5, wherein said tungsten carbide granules have a size of 40/60 mesh with a hardness of greater than 1700 HV.
